(19) United States
(12) Patent Application Publication
(10) Pub. No.: US 2016/0360389 A1
(43) Pub. Date: Dec. 8, 2016

(54) SYSTEM AND METHOD FOR CUSTOMIZING SYMBOLS IN CONTACT ENTRIES

(71) Applicant: VONAGE NETWORK LLC, Holmdel, NJ (US)

(72) Inventors: Itay Bianco, Tel-Aviv (IL); Sagie Machlin, Rishon Lezion (IL); Royee Uriel Tichauer, Haifa (IL)

(21) Appl. No.: 14/733,392

(22) Filed: Jun. 8, 2015

(51) Int. Cl. H04W 4/16; H04M 1/725; H04M 3/493; H04M 3/44

(52) U.S. Cl. CPC H04W 4/16; H04M 3/44; H04M 1/7258; H04M 3/493

(57) ABSTRACT

Methods and systems for processing symbols in contact list entries are provided herein. In some embodiments, a method for controlling one or more features of a telephony system via a user device, comprises receiving a selection of a contact in a contact list to establish a communication session from the user device; parsing a dial-string associated with the contact, wherein the dial string includes an identifier and one or more symbols, and wherein the one or more symbols are associated with one or more features of the user device; translating the one or more symbols into instructions to control the one or more features; and initiating the telecommunication session based on the instructions.

### BACKGROUND

### Field

Embodiments of the present invention generally relate to systems and methods for customizing symbols in contact list entries.

### Description of the Related Art

DTMF symbols make interacting with an interactive voice response (IVR) system more convenient for users. For example, a contact for a conference call may have a dial string of 7321234567;123,456, where the symbol “;” is a wait symbol and the symbol “,” is a pause symbol. A call is placed to the number preceding the wait symbol. When the call connects, a button may be displayed on a user device, which upon tapping, causes the DTMF tones 123 to be transmitted. After a pause of, for example, 2 seconds, the DTMF tones 4567 are transmitted. However, current DTMF symbols may create issues when interacting with the IVR system, for example transmitting before the IVR system is ready to receive the DTMF tones. A user may add extra symbols, for example, “,,,” to pause for a longer duration; however this is inefficient and may also be ineffective if the pause is still not long enough for the IVR system.

Thus, there is a need for processing customized symbols in contact list entries.

### SUMMARY

Methods and systems for controlling one or more features of a telephony system via a user device are provided herein. In some embodiments, a method for controlling one or more features of a telephony system via a user device comprises receiving a selection of a contact in a contact list to establish a communication session from the user device; parsing a dial-string associated with the contact, wherein the dial string includes an identifier and one or more symbols, and wherein the one or more symbols are associated with one or more features of the user device; translating the one or more symbols into instructions to control the one or more features; and initiating the telecommunication session based on the instructions.

In some embodiments, a system for controlling one or more features of a telephony system via a user device is provided. The system comprises a dial string processor configured to receive a selection of a contact in a contact list to establish a communication session from the user device and parse a dial-string associated with the contact, wherein the dial string includes an identifier and one or more symbols, and wherein the one or more symbols are associated with one or more features of the user device. The dial string processor is further configured to translate the one or more symbols into instructions to control the one or more features; and initiate the telecommunication session based on the instructions. In addition, the system comprises a dial string builder configured to generate dual-tone multi-frequency (DTMF) dial strings in contact entries based on an interactive voice response (IVR) interaction.

In some embodiments, a method for generating a dual-tone multi-frequency (DTMF) dial string in a contact entry based on an interactive voice response (IVR) interaction comprises method for generating a dual-tone multi-frequency (DTMF) dial string in a contact entry based on an interactive voice response (IVR) interaction, where the method comprises recording an IVR interaction; analyzing the recorded IVR interaction; and generating a dial string based on the analyzed IVR recording.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 a block diagram of various elements of a processor that forms part of an IP telephony system, in accordance with one or more embodiments of the invention;

FIG. 3 illustrates some of the elements that are present in a mobile device, according to one or more embodiments of the invention;

FIG. 4 depicts a flow diagram of a method for customizing symbols in contact list entries, according to one or more embodiments of the invention; and

FIG. 5 depicts a flow diagram of a method for generating a dial string in a contact entry based on a communication session with an IVR system, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to systems and methods for customizing symbols in contact entries. More specifically, embodiments of the present invention define enhanced instructions for processing custom DTMF symbols integrated into contact information. DTMF symbols in a contact entry define when DTMF tones should be played, for example, identifying when to wait for silence or wait for noise before transmitting the DTMF tones. DTMF symbols also identify when to automatically disconnect a call, such as after a delay or after the DTMF tones are sent. In addition, DTMF symbols are defined that signify special features to be enabled when a call is initiated, for example, start a call on mute, using the BLUETOOTH® wireless standard, on speaker, start the call as a video call, or an instruction not to playback the tones so the tones cannot be heard by anyone. DTMF symbols may be defined that identify when to replace the information in the contact information with DTMF tones stored in a table. The information in the table may be numbers, text, text that is to be converted to audio before transmission, recorded audio, and the like. In some embodiments, telecommunication sessions with an interactive voice response system (IVR) may be used to create custom DTMF contact entries.

Some portions of the detailed description that follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

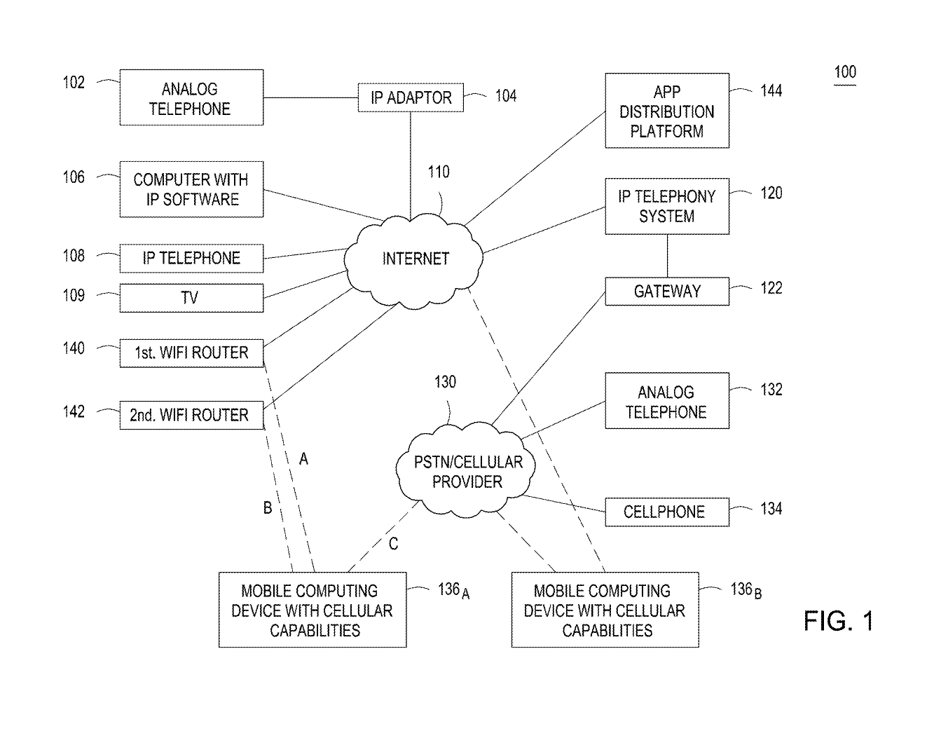

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may be provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device 136A with cellular capabilities (e.g., a smartphone) is capable of establishing a first wireless data connection A with a first wireless access point 140, such as a wireless local area network (WLAN) router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the wireless local area network (WLAN) based on the Institute of Electrical and Electronics Engineers' (IEEE) 802.11 and 802.13 standards. Similarly, mobile computing device with cellular capabilities 136B may also be coupled to internet 110 and/or cellular service provider 130. In some embodiments, mobile computing device 136B may be connected to internet 110 via a wireless local area network (WLAN) based on the Institute of Electrical and Electronics Engineers' (IEEE) 802.11 and 802.13 standard connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

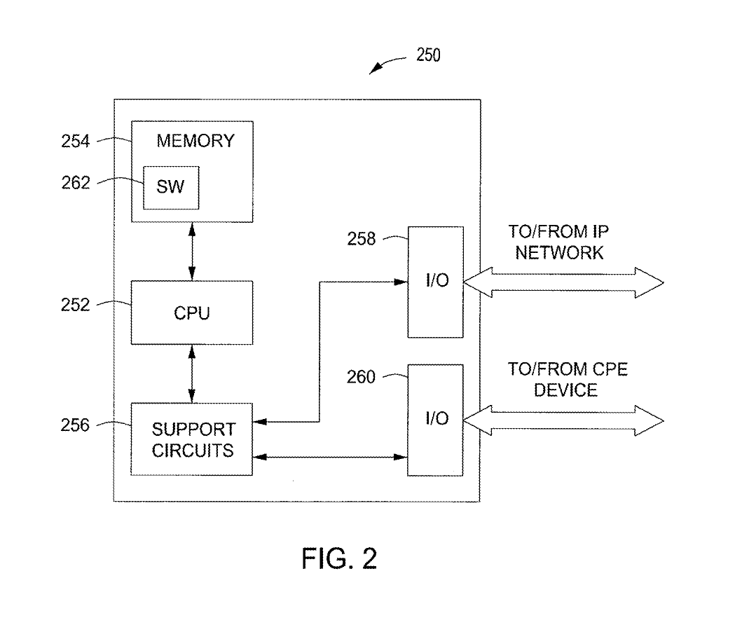

FIG. 2 illustrates elements of a computer processor 250 that can be used as part of the IP telephony system 120 to accomplish various functions. The IP telephony system 120 could include multiple processors 250 located at various locations in the system, along with their operating components and programming, each carrying out a specific or dedicated portion of the functions performed by the VoIP based telephony service 120. Further, a mobile telephony device 136 or some other IP telephony device could make use of one or more of the processors 250 to accomplish various functions.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, service provider agent equipment, other system 120 components, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120, or a mobile telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

The following description refers to IP telephony communications, or simply telephony communications. This phrase is intended to encompass any type of communication, including voice or video telephone calls, text messages and other forms of text-based, voice-based, or video-based messaging, as well as other forms of communications. Although the following examples may refer to a “call” or a “telephone call,” for ease of reference, clarity and brevity, the systems and methods described may also be used to accomplish other forms of communications.

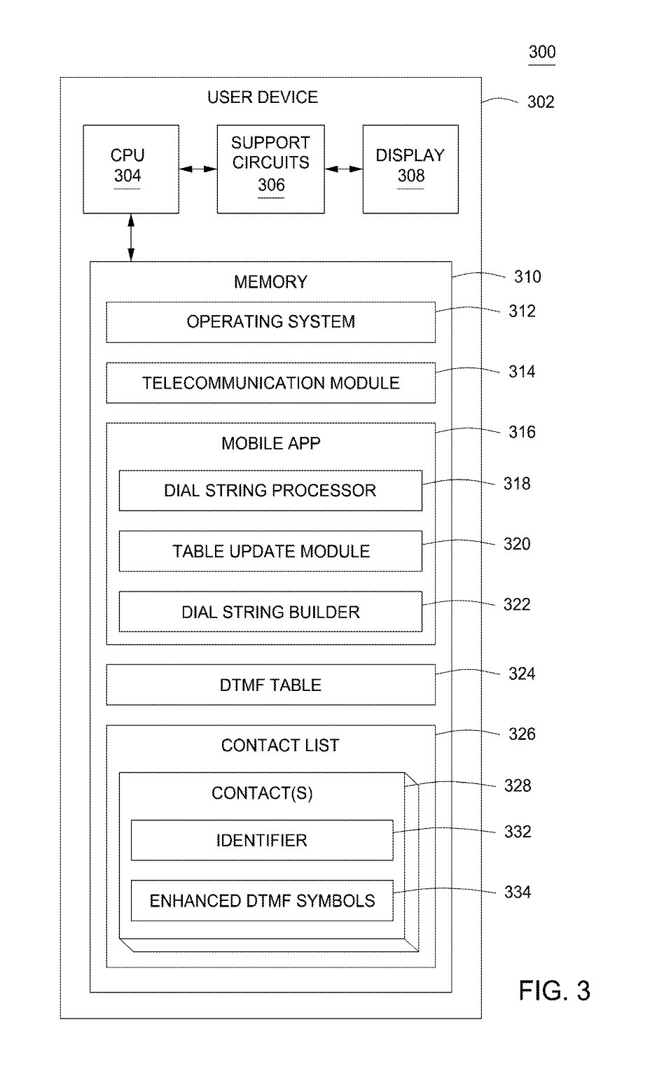

FIG. 3 illustrates some of the elements that are present in a mobile device 302, according to one or more embodiments of the present invention. The mobile device 302 may include any computer 106 with IP software, IP telephone 108, and/or mobile computing devices 136A, 136B with cellular capabilities, and the like, as shown in FIG. 1. The mobile device 302 comprises a Central Processing Unit (CPU) 304, support circuits 306, display 308, and a memory 310. The CPU 304 may comprise one or more commercially available microprocessors or microcontrollers that facilitate data processing and storage. The various support circuits 306 facilitate the operation of the CPU 304 and include one or more clock circuits, power supplies, cache, input/output circuits, and the like. The memory 310 comprises at least one of Read Only Memory (ROM), Random Access Memory (RAM), disk drive storage, optical storage, removable storage and/or the like. In some embodiments, the memory 310 comprises an operating system 312, a telecommunication module 314, a mobile application 316, a DTMF table 324, and a contact list 326.

The operating system (OS) 312 generally manages various computer resources (e.g., network resources, file processors, and/or the like). The operating system 312 is configured to execute operations on one or more hardware and/or software modules, such as Network Interface Cards (NICs), hard disks, virtualization layers, firewalls and/or the like. Examples of the operating system 312 may include, but are not limited to, LINUX, MAC OSX, BSD, UNIX, MICROSOFT WINDOWS, IOS, ANDROID and the like. In some embodiments, operating system 312 may include an application programming interface (API) which can be used to access user device information and features (such as, for example, by mobile app 316).

Telecommunication module 314 may be used to facilitate, or otherwise provide, communication connection services such as, for example, voice or video calling, or various other types of communication services. In some embodiments of the invention, such communication connection may be a standard 3G/4G mobile communication connection established using telecommunication module 314. In some embodiments, the communication connection may be a wireless local area network (WLAN) based on the Institute of Electrical and Electronics Engineers' (IEEE) 802.11x standards connection. Those skilled in the art of wireless communications know that other types of communication connections/environments exist and can be readily accessed with the appropriate types of hardware and signaling protocols and are considered within the scope of the invention. For example, BLUETOOTH and other, less known networks may be used. In addition, although described in terms of wireless communications, the inventive features of embodiments described herein can also apply to devices connecting to a LAN using wired technology.

The mobile application 316 may include a dial string processor 318, a table update module 320, and a dial string builder 322. In some embodiments, the mobile application 316 may be an over-the-top (OTT) telecommunication application. The contact list 326 may include a plurality of contacts 328. Each contact 328 may include at least one contact identifier in the form of a dial string 330. The dial string 330 may include an identifier 332 (e.g., telephone number, SKYPE® user identifier, etc.) and one or more enhanced DTMF symbols 334. Although the following invention is described using a telephone number, this is merely illustrative. As will be appreciated by those skilled in the art, any type of contact identifier may be utilized.

Upon selection of a dial string 330 from a contact 328, the dial string processor 318 parses the dial string 330. The dial string processor 318 translates the dial string 330 into a telephone number. A telephone number is a sequence of digits assigned to a fixed-line telephone subscriber station connected to a telephone line or to a wireless electronic telephony device, such as a radio telephone or a mobile telephone, or to other devices for data transmission via the PSTN 130, IP telephony system 120, or other private networks. A telephone number serves as an address for switching telephone calls using a system of destination routing. Telephone numbers are entered or dialed by a calling party on the originating telephone set which transmits the sequence of digits in the process of signaling to a telephone exchange. The exchange completes the call either to another locally connected subscriber or via the PSTN 130 or IP telephony system 120 to the called party.

The dial string processor 318 also translates any additional enhanced DTMF symbols 334 in the dial string 330. Each enhanced DTMF symbol 334 defines an instruction to be followed when initiating a call or during an established call. Several non-limiting examples are presented below.

In a first example, an IVR system may not accept DTMF tones that are transmitted when the IVR is still “talking”. In existing systems, a user would need to determine how long to wait before the IVR is ready to receive input and add multiple pause symbols (e.g., multiple “,” symbols). However, in embodiments consistent with the present invention, a single symbol, for example, an “s” or “S” symbol may translate into an instruction for the dial string processor 318 to “wait for silence” before transmitting the DTMF tones. In such case, a dial string 330 of “7325554567s123” causes the dial string processor 318 to initiate a call to telephone number 7325554567. After the call connects, the dial string processor 318 inspects incoming packets from an IVR system. When the dial string processor 318 detects a silence, the dial string processor 318 then transmits the DTMF tones “123”. In some embodiments, silence may be detected by identifying when the volume of an audio packet is below a predefined threshold. In some embodiments, specific packets may be received that indicate a silence; however, any algorithm that detects silence in a telecommunication session or data stream may be utilized.

In another example, an IVR system may not be ready to receive DTMF tones because the IVR system has not moved to, for example, a next menu. To ensure the DTMF tones are sent only when the new menu IVR has started playing, a “wait for noise” symbol (e.g., an “n” or “N” symbol), may be added to the dial string 330 which instructs dial string processor 318 to wait until noise is detected before transmitting the DTMF tones. More specifically, after the call is initiated, the dial string processor 318 inspects incoming packets to determine when the volume of the audio is above a predefined threshold. At such time, the dial string processor 318 transmits the DTMF tone(s) following the “wait for noise” symbol. In some embodiments, the dial string processor 318 waits for the volume of the audio to be above the predefined threshold for a predefined amount of time, for example, 2 seconds, before transmitting the DTMF tones.

Oftentimes, a user needs to transmit DTMF tones that change occasionally. For example, a conference participant may need to enter a user PIN after calling into the conference call, where the user PIN may change. In some embodiments, the user may define custom symbols in the DTMF table 324 that can be used to lookup values that replace the symbol in the dial string 330. For example, a user may assign the user PIN to a symbol (e.g., PIN) in the DTMF table 324. The symbol may be used in the dial string to incorporate the user PIN assigned to the symbol. For example, a dial string 330 for a contact may be “7325551234N@PIN@”. The dial string processor 318 parses the dial string 330. The “@” symbol instructs the dial string processor 318 to perform a lookup in the DTMF table 324. The “@” symbol is merely used for illustrative purposes. Any predesignated character or set of characters may be used to instruct the dial string processor 318 to perform a substitution from the DTMF table 324. The one or more characters may include any UNICODE® character. In the present example, @PIN@ translates into an instruction for the dial string processor 318 to access DTMF table 324 and replace PIN in the dial string 330 with an entry in the DTMF table 324 associated with the symbol PIN. For example, the entry associated with a PIN of “123” results in a dial string 330 of “7325551234N123”. The call is placed to telephone identifier 7325551234. Upon connection, the dial string processor 318 waits for noise (per the “N” symbol), converts the values “123” into DTMF tones, and then transmits the DTMF tones. A dial string that includes a manual lookup symbol, for example, “@@” opens the DTMF table 324 in a user interface and allows the user to manually select an entry from the DTMF table 324 via a user interface. The selected entry is substituted for the “@@” symbol in the dial string 330. A user may edit the DTMF table 324 in order to define customized symbols that meet the user's needs. In some embodiments, where the one or more characters that instruct the dial string processor 318 to perform a substitution from the DTMF table 324 are characters not present on a user's keyboard, a button may be displayed to add such characters to the dial string 330.

In some circumstances, a user often starts a call in a specific mode. For example, when a user joins a classroom conference session, the user may frequently want to join the conference session with the user's device on mute. A child may frequently engage in video calls with a grandparent. Rather than have a user manually select mute, BLUETOOTH, video, etc. after the call is connected, symbols may be defined that translate into an instruction for the dial string processor 318 to initiate the call for example, on mute, on speaker, using BLUETOOTH, start the call as a video call, etc.. The dial string processor 318 uses application programming interface (API) calls to the operating system to manipulate the user device, for example, to mute or unmute, turn on or off a camera for video, turn on or off a speaker, activate the BLUETOOTH, send email or a message when initiating a call, display information for a given contact, for example, last time talked, and the like. Symbols may be defined that translate into an instruction for the dial string processor 318 to manipulate any features of a user device that may be provided by APIs of the operating system.

Often, when joining a conference call, a user is asked to speak the user's name after entering the conference number. A symbol may be defined to play an audio message. The audio message may be recorded or the audio message may be generated by a text-to-speech converter (not shown). For example, a dial string 330 of “7325551234N98765N@NAME@” may cause the dial string processor 318 to access the DTMF table 324 to replace the @NAME@ symbol with a link to an audio file that plays the user's name. Alternatively, the dial string 330 may cause the dial string processor 318 to access the DTMF table 324 to replace the @NAME@ symbol with a the user's name with an instruction to convert the text of the user's name to speech. Thus, the dial string processor 318 connects the call to telephone number 7325551234, waits for noise, transmits the DTMF tones 98765, waits again for noise, and finally, transmits the audio of the user's name. The table update module 320 may be used to create, update, and delete entries in the DTMF table 324.

Further, a symbol may be defined that instruct the dial string processor 318 to automatically disconnect the call after the DTMF tones are transmitted. For example, users frequently use their devices to transmit signals to open gates or garage doors. A user may have a dial string 330, for example, “7325551234,3454D” in a contact list 326, where the symbol “D” translates into an instruction to disconnect the call. Upon selection of the contact 328, the dial string processor 318 connects the call to telephone number 7325551234, waits 2 seconds, transmits the DTMF tones 3453, which may open the gate, and then disconnects the call.

With the ubiquitous use of devices in public places, privacy is a concern for many users. As such, an enhanced DTMF symbol 334 may be defined that instructs the dial string processor 318 to not playback DTMF tones in a dial string 330 so the tones cannot be overheard by others and stolen. In some embodiments, the enhanced DTMF symbol 334 may instruct the dial string processor 318 to lower the volume of the user device to a lowest setting when the DTMF tones are being transmitted. In some embodiments, the enhanced DTMF symbol 334 may stop the playback of DTMF tones so the tones cannot be heard.

A dial string builder 322 may be used to generate a dial string 330 based on a recorded IVR message and DTMF tones. For example, when a user calls an IVR, the user may press a button that instructs the dial string builder 322 to start recording. In some embodiments, the dial string builder 322 starts recording automatically without user intervention. The dial string builder 322 records the telephone number, the IVR message, the time between when the IVR message played and the DTMF tones are input, and the DTMF tones that are transmitted. The dial string builder 322 generates the dial string 330 with the DTMF tones and the delays based on the recorded information. For example, a user may dial a telephone number, for example 7325551234, hear an IVR message that plays for four seconds, enter DTMF tones “567”, and then continue with the call. The dial string builder 322 generates the dial string “7325551234,,,567” and displays the dial string to the user with a prompt to save the contact. If the user chooses to save the contact, a window opens for adding a contact with the dial string filled in.

In some embodiments, the recorded IVR interaction is stored. When a user places a call, the IVR message received after the call connects is compared to the stored IVR interaction. If the received message matches the IVR message in the stored IVR interaction, then after the IVR message is played, the DTMF tones stored in the IVR interaction are transmitted. For example, when an IVR message “Please enter PIN” is received, the user enters their PIN to join a conference. This interaction is stored. Using this method, instead of adding a 4 second delay or waiting for silence to a dial string, when an IVR message “Please enter PIN” is received on a current call, the previously recorded “please enter PIN” is compared to the received message in a current call. The two audio streams are synced such that when the recorded message starts playing the DTMF tones, the dial string processor 318 plays the same DTMF tones that were stored.

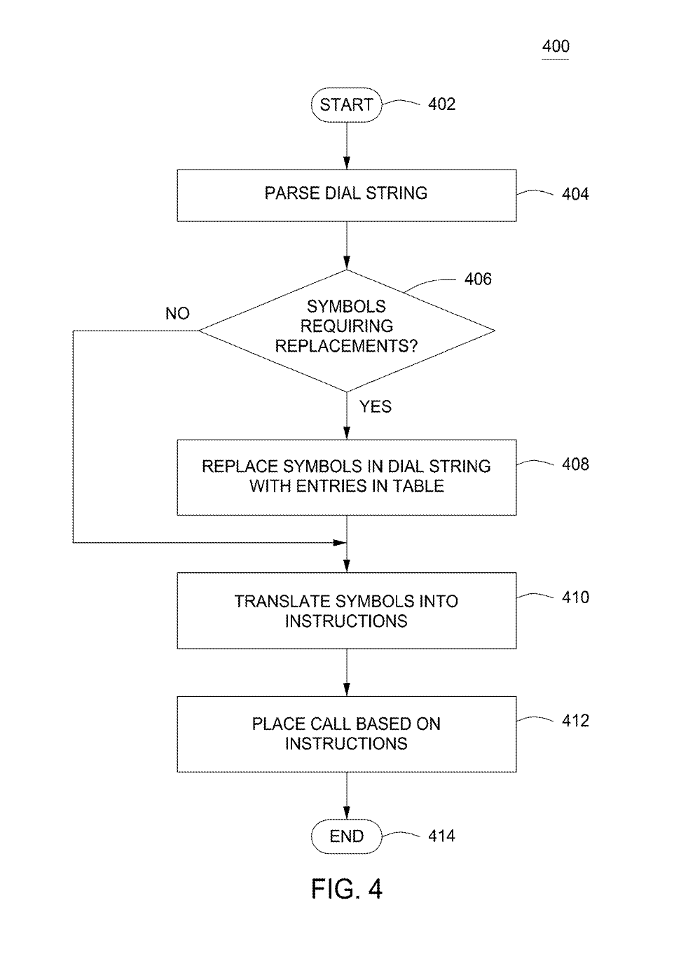

FIG. 4 depicts a flow diagram of a method 400 for customizing symbols in contact list entries, according to one or more embodiments of the invention. The method 400 starts at step 402 and proceeds to step 404.

At step 404 a dial string is parsed. A dial string is selected from a contact in a contact list. The dial string includes a telephone number to an IVR system as well as symbols that translate into instructions for interacting with the IVR system. The symbols may translate into instructions regarding when to send DTMF tones. The symbols may translate into instruction regarding special features to activate when initiating the call, for example, start the call on mute, speaker, Bluetooth, or on video. The symbols may translate into an instruction to replace the symbol with an entry in a DTMF table. The entry may include DTMF tones, text, audio, and the like. For example, the dial string for calling into a conference call may be “7325551234N654321S@NAME@M”. In the present example, when calling into the conference call, the IVR requests a conference ID. When the conference ID is verified, the IVR system requests that you say your name, which may be played for the other participants in the conference call.

At step 406, it is determined whether symbols are present in the dial string that require the symbol to be replaced with an entry in the DTMF table. For example, the dial string may include a symbol, for example, “@PIN@” or “%PIN%” or any symbol that translates into an instruction to replace the symbol with an entry from the DTMF table. If it determined that there are no symbols in the dial string that require replacement, the method 400 proceeds to step 410. However, if it is determined that there are symbols in the dial string that require replacement, the method 400 proceeds to step 408.

At step 408, the symbols are replaced with an entry from the DTMF table. The symbol, for example, the “@” symbol or the “%” symbol, indicates the start and end of the data string that is used as a lookup in the DTMF table. For example, if the string is “PIN”, an entry associated with “PIN” is retrieved from the DTMF table. The entry may be DTMF tones, for example, “123”. The entry may be an audio file. The entry may be text, or any media that can be used with an IVR system. In the present example, an entry associated with the @NAME@ symbol is retrieved from the DTMF table. In the present example, “NAME” is associated with an audio file that plays, “Hi. This is John.” Alternately, the entry may be a text file that is converted to play, “Hi. This is John.”

At step 410, the remaining symbols are translated into instruction for interacting with the IVR system. In the present example, 7325551234N654321S@NAME@M is translated into instructions that cause the call to be placed to the telephone number 7325551234. The “N” character is translated into “wait for noise”, at which time, the DTMF tones 654321 may be transmitted. After the DTMF tones are transmitted, the “S” character is translated into “wait for silence”, at which time the audio file plays the statement “Hi. This is John”. Finally, the “M” symbol translates into an instruction to mute the user device.

At step 412, the call is placed based on the translated instructions. The method 400 ends at step 414.

In some embodiments, the dial string or DTMF table selection is received as input during an established call (i.e., after the call has been initiated). For example, a user may call into a conference call to a number that is not in the contact list of the user. The user may be requested to, for example, enter a PIN, state the user's name, and the like. When the request is received, the user may access, for example the DTMF table and select the appropriate input from the DTMF table, for example, the user's PIN or audio file of the user's name. The selection is then transmitted to the IVR system.

Further, the present invention may be used for incoming calls. For example, a conference call system may initiate a call to the user. When the user answers, the conference call system may request the user to state the user's name, enter a PIN, and the like. As described above, the input may be selected by the user from the DTMF table. In some embodiments, the callerID of the incoming call is compared to identifiers in the user's contact list. If a match is found, the requested information is extracted from the dial string of the contact, and transmitted automatically to the IVR system.

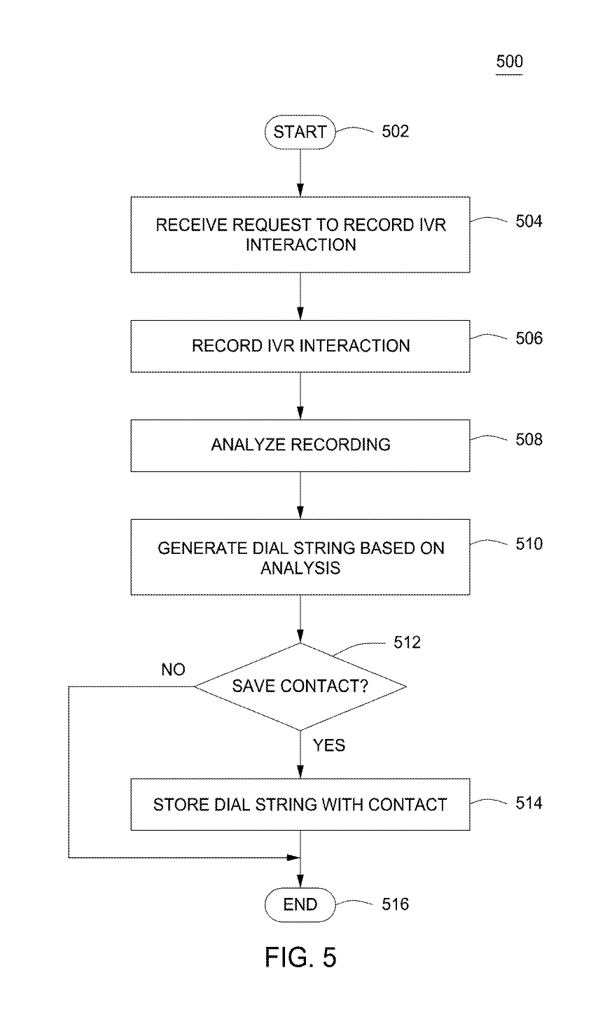

FIG. 5 depicts a flow diagram of a method 500 for generating dial strings based on a communication session with an IVR system, according to one or more embodiments of the invention. The method 500 starts at step 502 and proceeds to step 504.

At step 504, a request is received to record an IVR interaction. In some embodiments, the request is received in response to a user input request to record the IVR interaction. In some embodiments, the request is initiated automatically when a call is initiated.

At step 506, the IVR interaction is recorded. The interaction may include a telephone number to an IVR system, IVR messages, DTMF tones entered, and the like.

At step 508, the recording is analyzed. For example, an amount of time between when the call connects and when the IVR message is determined, a duration of the IVR message is calculated, any additional IVR messages/menus and DTMF tones or audio, etc.

At step 510, a dial string is generated based on the analyzed recording. For example, if after the call connects, an IVR message that is four seconds is played and then DTMF tones are entered, the dial string is generated to include the dialed telephone number, followed by two “;” symbols, and the DTMF tones. The two “;” symbols will translate into an instruction to wait four seconds before transmitting the DTMF tones. In the present example, the four seconds provide enough time for the IVR message to complete and ensuring the IVR system is ready to receive the DTMF tones.

At step 512, it is determined whether the user would like to save the generated dial string in a contact list. The user is prompted to save the contact. If the user opts not to save the contact, the method 500 proceeds to step 516 and ends. However, if the user chooses to save the generated dial string as a contact, then at step 514, a window opens that enables the user to add contact information. The generated dial string is displayed in the contact entry and may be edited by the user. The contact is then stored in the contact list. The method 500 ends at step 516.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example, but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.RTM, Smalltalk or C++, PERL®, PYTHON®, JAVASCRIPT®, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for controlling one or more features of a telephony system via a user device, comprising:
receiving a selection of a contact in a contact list to establish a telecommunication session from the user device;
parsing a dial-string associated with the contact, wherein the dial-string includes an identifier and one or more symbols, and wherein the one or more symbols are associated with one or more features of the user device;
translating the one or more symbols into instructions to control the one or more features; and
executing the instruction in the telecommunication session.

2. The method of claim 1, wherein the one or more symbols are enhanced DTMF symbols.

3. The method of claim 1, wherein the one or more features that are controlled by the one or more symbols includes at least one of a mute feature, speaker usage, BLUETOOTH® wireless standard usage, or video calling.

4. The method of claim 1, wherein the dial-string further comprises one or more enhanced DTMF symbols that translate into one of an instruction to wait for silence before transmitting the one or more DTMF tones or an instruction to wait for noise before transmitting the one or more DTMF tones.

5. The method of claim 1, wherein the dial-string further comprises a replacement symbol, wherein the replacement symbol translates into an instruction to replace the replacement symbol in the dial-string with an entry from a DTMF table.

6. The method of claim 5, wherein the entry comprises one of values to convert into DTMF tones, an audio file, or a text string.

7. The method of claim 5, wherein the entry to replace the replacement symbol is based on a selection received via a user interface.

8. The method of claim 1, further comprising an enhanced DTMF symbol that translates into an instruction to terminate the telecommunication session after DTMF tones are transmitted.

9. The method of claim 1, further comprising an enhanced DTMF symbol to silence playback when DTMF tones are transmitting.

10. A system for controlling one or more features of a telephony system via a user device, comprising:
a dial string processor configured to:
receive a selection of a contact in a contact list to establish a telecommunication session from the user device;
parse a dial-string associated with the contact, wherein the dial-string includes an identifier and one or more symbols, and wherein the one or more symbols are associated with one or more features of the user device;
translate the one or more symbols into instructions to control the one or more features; and
execute the instruction in the telecommunication session; and
a dial string builder configured to:
generate dual-tone multi-frequency (DTMF) dial-strings in contact entries based on an interactive voice response (IVR) interaction.

11. The system of claim 10, wherein the one or more symbols are enhanced DTMF symbols.

12. The system of claim 10, wherein the one or more features that are controlled by the one or more symbols includes at least one of a mute feature, speaker usage, BLUETOOTH® wireless standard usage, or video calling.

13. The system of claim 10, wherein the dial-string further comprises one or more enhanced DTMF symbols that translate into one of an instruction to wait for silence before transmitting the one or more DTMF tones or an instruction to wait for noise before transmitting the one or more DTMF tones.

14. The system of claim 10, wherein the dial-string further comprises a replacement symbol, wherein the replacement symbol translates into an instruction to replace the replacement symbol in the dial-string with an entry from a DTMF table.

15. The system of claim 14, wherein the entry from the DTMF table comprises one of values to convert into DTMF tones, an audio file, or a text string.

16. The system of claim 14, wherein the entry to replace the replacement symbol is based on a selection received via a user interface.

17. The system of claim 10, further comprising an enhanced DTMF symbol that translates into an instruction to terminate the telecommunication session after the DTMF dial-strings are transmitted.

18. The system of claim 10, further comprising an enhanced DTMF symbol to silence playback when DTMF dial-strings are transmitting.

19. A computer-implemented method for generating a dual-tone multi-frequency (DTMF) dial string in a contact entry based on a communication session with an interactive voice response (IVR) system, comprising:
recording, by a dial-string processor, an IVR interaction in a DTMF table;
analyzing, by the dial-string processor, the recorded IVR interaction to determine IVR properties; and
generating a dial string based on the analyzed IVR recording and the IVR properties.

20. The method of claim 19,
wherein analyzing the recorded IVR interaction comprises:
identifying an identifier;
determining a time duration of one or more IVR messages in the IVR interaction; and
identifying one or more recorded dual-tone multi-frequency (DTMF) tones entered after each of the IVR messages; and identifying one or more user audio statements and storing the one or more user audio statements; and
wherein generating the dial string comprises:
inserting one or more enhanced DTMF symbols in the dial string that cause one or more recorded DTMF tones to be transmitted after each of one or more IVR messages has completed playing; and
inserting one or more replacement symbols in the dial string that are associated with the one or more stored user audio statements.

21. A computer implemented method for controlling a request by an IVR system comprising:
receiving at a dial string processor, during an established telecommunication session, an input of one of a dial-string associated with a contact in a contact list or a selection of an entry from a DTMF table, wherein the dial-string comprises one or more symbols that translate into one of an instruction to wait for silence before transmitting the one or more DTMF tones or an instruction to wait for noise before transmitting the one or more DTMF tones, and wherein the entry comprises one of values to convert into DTMF tones, an audio file, or a text string;
translating, by the dial string processor, the input into instructions based on a DTMF table; and
transmitting the instructions to the IVR system during the established telecommunication session.

22. The method of claim 21, wherein the dial-string further comprises a replacement symbol, wherein the replacement symbol translates into an instruction to replace the replacement symbol in the dial-string with an entry from a DTMF table.
